(19) United States
(12) Patent Application Publication
(10) Pub. No.: US 2009/0323509 A1
(43) Pub. Date: Dec. 31, 2009

(54) METHOD OF TRANSMITTING DATA SIGNALS IN A TELEPHONE NETWORK

(76) Inventor: Gael Hendryckx, Sartrouville (FR)

Correspondence Address: Muncy, Geissler, Olds & Lowe, PLLC, P.O. BOX 1364, FAIRFAX, VA, 22038-1364, US

(21) Appl. No.: 12/375,160

(22) PCT Filed: Jul. 6, 2007
(86) PCT No.: PCT/FR2007/001152

§ 371 Date: Jan. 26, 2009

(30) Foreign Application Priority Data
Jul. 26, 2006 (FR) 06 06830

(51) Int. Cl. H04J 11/00

(52) U.S. Cl. 370/208

(57) ABSTRACT

A method of transmitting a data signal in a telephone network that is accessible via a vocoder and means for transmitting voice signals, the method comprising the steps of obtaining a modulated signal by subdividing the data signal into frames associated with mutually orthogonal states of a set of carriers (OFDM), processing the modulated signal in the vocoder, and delivering the processed signal to the voice signal transmission means.

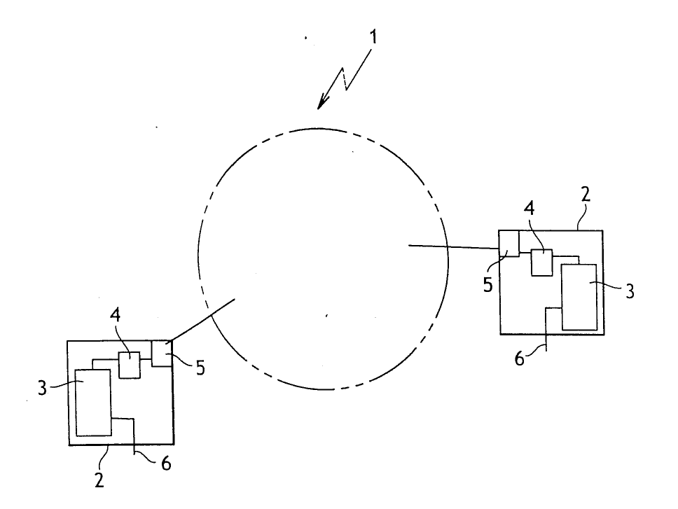

### BACKGROUND OF THE INVENTION

1. Field of the Invention

The present invention relates to a method of transmitting data signals in a telephone network.

2. Brief Discussion of the Related Art

A telephone network is generally accessible by means of a terminal, such as a telephone set, that includes a vocoder and voice signal transmission means, e.g. incorporating coder/decoder means, filter means, compression means, and a communications protocol that together are adapted to transmit voice signals without degrading them.

Proposals have been made to transmit data signals using the telephone network as a medium. By way of example, data signals are used for controlling a terminal or for transporting voice that has been enciphered. Nevertheless, the characteristics of data signals are very different from the characteristics of voice signals such that the vocoder and the voice signal transmission means degrade data signals, in particular while performing compression.

In order to remedy this problem, data signal transmission means have been associated with the voice signal transmission means. The data signal transmission means are analogous to the voice signal transmission means, but they are specially adapted to transmit data signals without degrading them.

It nevertheless happens that telephone network operators limit the uses to which data transmission means can be put, in particular for economic reasons, or that government blocks data calls such that it is not possible to transmit data signals over the network.

In addition, public spaces, hotels, and other places where people pass do not all have means for connection to the telephone network enabling a modem to be used so that data signal transmission means can be used.

Furthermore, not all telephone networks are adapted to the use of such data transmission means, thereby making it impossible to transmit data signals without the signals being strongly degraded.

### OBJECT OF THE INVENTION

An object of the invention is to provide means enabling data signals to be transmitted over a telephone network without having recourse to dedicated transmission means.

### SUMMARY OF THE INVENTION

To this end, the invention provides a method of transmitting a data signal in a telephone network that is accessible via a vocoder and means for transmitting voice signals, the method comprising the steps of:
obtaining a modulated signal by subdividing the data signal into frames associated with mutually orthogonal states of a set of carriers (OFDM);
processing the modulated signal in the vocoder; and
delivering the processed signal to the voice signal transmission means.

Surprisingly, the structure of the data signal after OFDM modulation is close to that of a voice signal, such that being passed through the vocoder and the voice signal transmission means degrades the data signal little or not at all. The data signal can thus be transmitted over the telephone network by using the voice signal transmission means, and thus without having recourse to dedicated data signal transmission means.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing, which are given by way of illustration only, and thus are not limitative of the present invention, and wherein:

The accompanying figure constitutes a diagram of a telephone network enabling the method of the invention to be implemented.

### DETAILED DESCRIPTION OF THE INVENTION

The telephone network, given overall reference 1, comprises terminals 2 enabling users of the network 1 to establish calls between one another via the network 1. In known manner, the network 1 may make use of transmission by wire or by radio, or it may combine both modes of transmission.

Each terminal 2 both sends and receives, and comprises a transformation module 3 connected via processor module 4 to transmission means 5 providing the connection between the terminal 2 and the network 1.

The processor module 4 is arranged is known manner to perform a voice activity detection (VAD) function so as to insert comfort noise into signals for sending that include blanks, the comfort noise taking the place of the blanks, and also to perform a voice encoder or “vocoder” function.

The vocoder function is itself known and here it is of the “full rate”, “enhanced full rate”, or “half-rate” GSM type, and during sending it serves to analyze the spectrum of the signals and to encode said signals for transmission over the network 1 via the transmission means 5. The processor module 4 also performs decoding of signals it receives on reception. The processor module 4 forms one of the components that is conventional for a terminal 2.

In known manner, the transformation module 3 includes a processor and a memory for storing signals prior to sending them to the processor module 4.

Each terminal 2 operates in conventional manner for sending and receiving voice signals via a microphone and a loudspeaker (not shown here). The sending and the receiving of voice signals are therefore not described herein.

The processor of the transformation module 3 performs an algorithm that is arranged to produce a signal modulated on the basis of a data signal provided via a connection member 6 by a device (not shown) for providing data signals, here a voice enciphering device (such a device comprising a vocoder associated with an enciphering module delivering enciphered data, e.g. using a 128-bit AES algorithm).

The transformation module 3 is arranged to subdivide each received data signal into frames associated with mutually-orthogonal states of a set of carriers, and performs correction encoding by means of a coded orthogonal frequency division multiplexing (COFDM) algorithm. The parameters of the algorithm are as follows:
32 carriers modulated by phase-shift keying (PSK) of the PSK-2 type;
the carrier frequencies are spaced apart by 50 hertz (Hz), with the minimum frequency being about 1000 Hz;
the number of symbols is 50 symbols per second;
there is no guard time.
   The processor is also arranged:
to assemble all of the payload data into frames comprising 736 bits, of which 400 are occupied by payload data;
to perform error coding by means of a low density parity check (LDPC);
to insert a blank every four frames; and
to introduce a resynchronization frame very four frames.

Inserting blanks between successive frames serves to cause the modulated signal to fluctuate in such a manner as to fool the voice activity detection. Voice activity detection relies on the presence of fluctuations in a voice signal representative of ongoing speech, while the absence of fluctuations is assumed to be silence that the processor of the processor module 3 replaces with a portion of the signal representing comfort noise. Without using such fluctuations in the modulated signal, the variation in the modulated signal is small, so it runs the risk of the processor considering the modulated signal to be essentially representative of a blank.

The vocoder 4 is arranged in such a manner that the frames of the signal processed by the vocoder 4 are interleaved on transport frames.

Naturally, the invention is not limited to the implementation described but covers any variant coming within the ambit of the invention as defined by the claims.

In particular, the modulation parameters may be different from those described, and the modulation may be performed by means of some other OFDM algorithm. Thus, the minimum frequency may be 800 Hz, and 40 carriers may be used with modulation being performed using PSK-4.

Although the implementation of the method of the invention is described as being performed using a terminal that combines the transformation module, the processor module, and the transmission means, the method can be implemented by a separate device, such as a headset device incorporating the transformation means and connectable via a wire, radio, or infrared connection to a conventional terminal (such as a mobile telephone or an Internet telephone set) that includes the processor module and the transmission means.

Causing the signal to fluctuate is optional and of use above all when in the presence of a voice activity detector.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of transmitting a data signal in a telephone network that is accessible via a vocoder and means for transmitting voice signals, the method comprising the steps of:
obtaining a modulated signal by subdividing the data signal into frames associated with mutually orthogonal states of a set of carriers (OFDM);
processing the modulated signal in the vocoder; and
delivering the processed signal to the voice signal transmission means.

2. A method according to claim 1, wherein correction coding is performed during modulation (COFDM).

3. A method according to claim 2, including a step of causing the modulated signal to fluctuate in order to fool a voice activity detector located upstream from the vocoder.

4. A method according to claim 3, in which the fluctuations are obtained by inserting a blank between successive frames.

5. A method according to claim 1, wherein the frequencies of the carriers are spaced about by 50 Hz, the minimum frequency being about 1000 Hz.

6. A method according to claim 1, wherein there are 32 carriers.

7. A method according to claim 1, wherein each carrier is modulated by phase-shift keying (PSK).
